(19) United States
(12) Patent Application Publication
(10) Pub. No.: US 2010/0083856 A1
(43) Pub. Date: Apr. 8, 2010

(54) Belted inker for a printing press

(75) Inventor: Tarquinio Andrew Bruno, Hampton, NH (US)

Correspondence Address: Davidson, Davidson & Kappel, LLC, 485 7th Avenue, 14th Floor, New York, NY, 10018, US

(73) Assignee: Goss International Americas, Inc., Durham, NH (US)

(21) Appl. No.: 12/286,941

(22) Filed: Oct. 3, 2008

(51) Int. Cl. B41F 31/00

(52) U.S. Cl. 101/350.2

(57) ABSTRACT

A printing unit is provided. The printing unit includes an ink feed system, a plate cylinder and an inker having multiple rollers and a belt wrapped around the rollers. The belt accepts ink from the ink feed system and transfers the ink to the plate cylinder. A method of printing and an inker are also provided.

The present invention relates generally to printing presses, and more particularly to inking apparatuses used in printing presses.

### BACKGROUND OF THE INVENTION

Many printing processes, such as the lithographic printing process, may use rollers and cylinders to deliver and apply ink to a substrate, such as a paper web. An ink metering system, such as a fountain and ductor roll, may apply ink at one end of an arrangement of rollers called an inker. As the rollers rotate, ink is transferred between adjacent rollers at roller contact locations, called nips. Eventually, ink is applied by the rollers to image areas on a plate cylinder containing text and images to be printed. The plate cylinder may then transfer the ink either directly to the substrate or to another rotating cylinder, called a blanket cylinder, which applies the ink to the substrate.

### SUMMARY OF THE INVENTION

A printing unit is provided. The printing unit includes an ink feed system, a plate cylinder and an inker having multiple rollers and a belt wrapped around the rollers. The belt accepts ink from the ink feed system and transfers the ink to the plate cylinder.

A method of printing is also provided. The method includes the steps of applying ink from the ink feed system to a belt, moving the belt along a path of the belt and transferring the ink from the belt to a plate cylinder.

An inker is also provided. The inker includes multiple rollers and an ink transfer belt wrapped around the rollers.

### BRIEF DESCRIPTION OF THE DRAWINGS

The present invention is described below by reference to the following drawings, in which:

FIG. 1 schematically shows a printing unit including an inker according to one embodiment of the present invention; and

FIG. 2 schematically shows a printing unit including an inker according to a further embodiment of the present invention.

### DETAILED DESCRIPTION

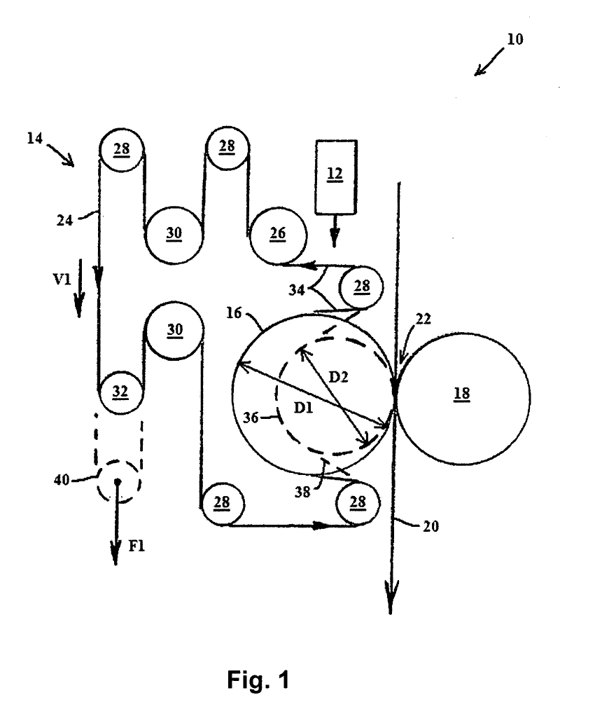

FIG. 1 describes a printing unit 10 according to the present invention, having an ink feed system 12, an inker 14, a plate cylinder 16, and a backup cylinder 18. Ink feed system 12 feeds ink into inker 14. Inker 14 delivers ink to plate cylinder 16. Plate cylinder 16 applies ink to a substrate 20 in a nip 22 formed between plate cylinder 16 and backup cylinder 18.

Inker 14 includes a belt 24, an outer idler roller 26, inner idler rollers 28, vibrator rollers 30 and a tensioning roller 32. Belt 24 wraps around idler rollers 28 and tensioning roller 32 and passes inside of idler roller 26, vibrator rollers 30 and plate cylinder 16, which assist in guiding belt 24 along a belt path 34. Belt 24 travels along belt path 34 at a velocity V1. Surfaces of idler roller 26, idler rollers 28 and vibrator rollers 30 adjacent to belt 24 also travel at velocity V1. Tensioning roller 32 applies a force F1 to keep belt 24 at a desired tension. Idler rollers 28, 36 may be rubber coated.

In one preferred embodiment, tensioning roller 32 may be driven to translate belt 24. In alternative embodiments of the present invention, a driven roller may be added to translate belt 24 or one of the idler rollers 28 may be replaced by a driven roller.

In one preferred embodiment, belt 24 may be a tooth-driven belt and tensioning roller 32 may include teeth to drive belt 24 to prevent belt 24 from slipping during velocity changes of printing unit 10. Slipping during operation may cause issues with surface quality and increase waste product. For a friction-driven embodiment of belt 24, a center cross-section of an inner perimeter of belt 24 may include a cut-out portion. The cut-out portion may limit an amount of lateral travel of belt 24, in relation to a center axis of plate cylinder 16, caused by vibrator rollers 30 or other forces during operation. Accordingly, idler rollers 28 and tensioning roller 32 may include circumferential protrusions that are received by the cut-out portion of belt 24 during operation.

The ink received by inker 14 from ink feed system 12 is transported by belt 24 to plate cylinder 16 along belt path 34. As belt 24 travels around idler roller 26 and vibrator rollers 30, ink thickness variations on belt 24 may be reduced by ink transfer between belt 24, idler roller 26, and vibrator rollers 30. Vibrator rollers 30 oscillate back and forth across the belt width to further reduce ink thickness variations. The ink transferred by belt 24 to plate cylinder 16 is replaced by additional ink from ink feed system 12 with each passage of belt 24 around belt path 34.

The present invention may simplify the process of changing a plate cylinder diameter D1. In the prior art, the rollers adjacent to the plate cylinder, called form rollers, are typically only capable of small movements normal to the plate surface and therefore may not easily accommodate a new plate cylinder 36 with a diameter D2, represented by a dashed circle in FIG. 1. In the present invention, new plate cylinder 36 may be more easily installed because belt 24 simply takes a new path 38 around new plate cylinder 36 and tensioning roller 32 moves to a new position 40. The ability to change print cylinder diameter may advantageously allow the length of printed images to be changed.

In the embodiment shown in FIG. 1, since a blanket cylinder is not used, new plate cylinder diameter D2 is not limited to being equal to a blanket cylinder diameter divided by some integer. Directly printing from plate cylinder 16 to substrate 20 thus may allow new plate cylinder diameter D2 to be more freely chosen.

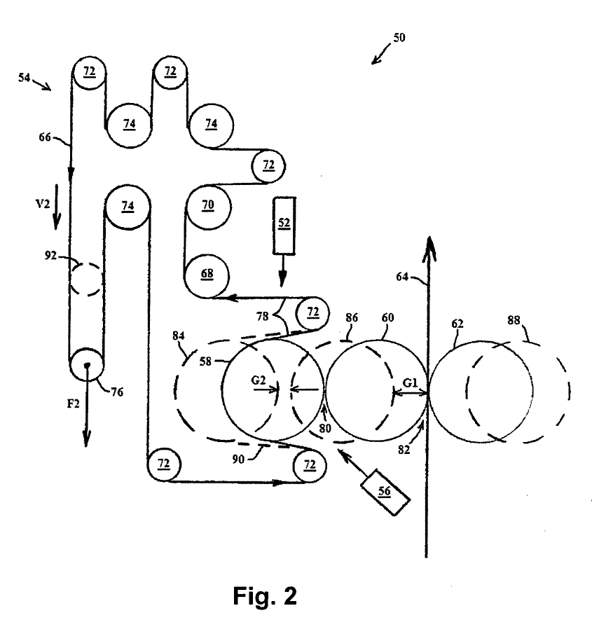

FIG. 2 describes a printing unit 50 according to the present invention, having an ink feed system 52, an inker 54, a water feed system 56, a plate cylinder 58, a blanket cylinder 60, and a backup cylinder 62. Ink feed system 52 feeds ink into inker 54. Inker 54 delivers ink to plate cylinder 58. Plate cylinder 58 applies ink to blanket cylinder 60, and blanket cylinder 60 applies ink to a substrate 64. In another embodiment, printing unit 50 may be a perfecting printing unit and backup cylinder 62 may be a blanket cylinder printing on the other side of substrate 64.

Water feed system 56 is used when the printing process is lithographic. Water feed system 56 delivers an aqueous solution, called fountain solution, to the plate so that ink sticks to the plate image areas and not to the non-image areas.

Inker 54 includes a belt 66, an outer idler roller 68, a rider roller 70, inner idler rollers 72, vibrator rollers 74, and a tensioning roller 76. Belt 66 wraps around idler roller 68, rider roller 70, idler rollers 72, vibrator rollers 74, and plate cylinder 58. Belt 66 travels around a belt path 78 at a velocity V2. The surfaces of idler roller 68, rider roller 70, idler rollers 72, and vibrator rollers 74 adjacent to belt 66 also travel at velocity V2. Tensioning roller 76 applies a force F2 to keep belt 66 at a desired tension.

In one preferred embodiment, tensioning roller 76 may be driven to translate belt 66. In alternative embodiments of the present invention, a driven roller may be added to translate belt 66 or one of the idler rollers 72 may be replaced by a driven roller.

In one preferred embodiment, belt 66 may be a tooth-driven belt and tensioning roller 76 may include teeth to drive belt 66 to prevent belt 66 from slipping during velocity changes of printing unit 50. Slipping during operation may cause issues with surface quality and increase waste product. In an alternative embodiment, belt 66 may be may be friction-driven. For a friction-driven embodiment of belt 66, a center cross-section of an inner perimeter of belt 66 may include a cut-out portion. The cut-out portion may limit an amount of lateral travel of belt 24, in relation to a center axis of plate cylinder 16, caused by vibrator rollers 30 or other forces during operation. Accordingly, idler rollers 72 and tensioning roller 76 may include circumferential protrusions that are received by the cut-out portion of belt 66 during operation.

The ink received by inker 54 from ink feed system 52 is transported by belt 66 to plate cylinder 58 along belt path 78. As belt 66 travels around idler roller 68, rider roller 70, and vibrator rollers 74, ink thickness variations on belt 66 may be reduced by ink transfer between belt 66 and idler roller 68, rider roller 70, and vibrator rollers 74. Vibrator rollers 74 oscillate back and forth across a width of belt 66 to further reduce ink thickness variations. The ink transferred by belt 66 to plate cylinder 58 is replaced by additional ink from ink feed system 52 with each passage of belt 66 around belt path 78.

The present invention may simplify the process of throwing plate cylinder 58 and blanket cylinder 60 off impression. During printing, plate cylinder 58 and blanket cylinder 60 are on impression, meaning plate cylinder 58 and blanket cylinder 60 are in contact to form a nip 80, and blanket cylinder 60 and backup cylinder 62 are in contact with substrate 64 to form a nip 82. Cylinders 58, 60 may be thrown off impression, so that plate cylinder 58 and blanket cylinder 60 move apart from one another creating a gap G1 between blanket cylinder 60 and substrate 64 and a gap G2 between plate cylinder 58 and blanket cylinder 60. The dashed circles in FIG. 2 show off impression locations 84, 86, 88 for plate cylinder 58, blanket cylinder 60, and backup cylinder 62, respectively. When blanket cylinder 60 is thrown off from substrate 64 and plate cylinder 58 is thrown off from blanket cylinder 60, and plate cylinder 58 and blanket cylinder 60 are at off impression locations 84, 86, respectively, a plate of plate cylinder 58 may be changed and a blanket on blanket cylinder 60 may be changed. Automated mechanisms such as autoplating may used for these changes.

In the prior art, throwing plate cylinder 58 and blanket cylinder 60 off impression typically requires moving form rollers out of the way. Designing form rollers to move with the plate cylinder is complicated and expensive. In the present invention, throwing plate cylinder 58 and blanket cylinder 60 off impression may be simplified because belt 66 simply takes a new path 90 around new position 84 of plate cylinder 58, and tensioning roller 76 moves to a new position 92.

The present invention provides for a large gap G1, which may facilitate auto-transfer. During auto-transfer a web continues to run through a printing press while blanket cylinders of one or more printing units are thrown off from the web. While the blanket cylinders are thrown off, blanket cylinders of one or more other printing units are printing images on the web. Plates and blankets of the printing units with the thrown off blanket cylinder may be changed, while the other printing units print, minimizing press downtime. Auto-transfer requires a large gap between blanket cylinders and the web so that the web may pass by the thrown off blanket cylinders without receiving ink from the thrown off blanket cylinders. The present invention simplifies auto-transfer because belt 66 may take new path 90 via a movement of tensioning roller 76.

By constructing inkers 14, 54 with belts 24, 66, the present invention simplifies inker setup and maintenance. Inkers may commonly have about twenty nips, each requiring setup and periodic adjustments for desired contact and tension. In the present invention, the contact between belts 24, 66 and adjacent rollers may be adjusted with tensioning rollers 32, 76. Also, where conventional inkers may have about ten rubber rollers that may become worn and need replacement, inkers 14 and 54 each have only one comparable item, belts 24, 66, respectively, that may become worn and need replacement. Since there are fewer nips to adjust and fewer items to replace, inker setup and maintenance may be thus advantageously simplified.

To minimize print defects such as doubling, inkers 14 and 54 may be driven independently from plate cylinders 16 and 58, respectively. Compliant contact over belts 24, 66 may further help isolate plate cylinders 16, 58 from torsional disturbances in inkers 14, 54.

Further embodiments are conceivable: ink feed systems 12, 52 may provide different ink feed rates across the web width, if desired; substrates 20, 64 may be either sheets or a web, and may be made of a variety of materials; multiple inkers may be used to print multiple color text and images; inker parameters, such as the number of rollers, the arrangement of rollers, the roller sizes, and belt length, may be varied to produce any desirable inker configuration; various ink feed systems, such as ink fountains, spray nozzles, and ink pumps, may be used; belts may be tooth-driven or friction-driven, for example; and vibrator roller lateral oscillation rate may be made independent of vibrator roller rotation rate.

Driving tensioning rollers 32, 76 with a drive system may allow the drive system to act as a tensioning system by moving the drive system on a hydraulic driven carriage having a proper structural integrity. Driving tensioning rollers 32, 76 may be advantageous because of the amount of surface contact between belts 24, 66 and tensioning rollers 32, 76, respectively, may increase the friction between belts 24, 66 and tensioning rollers 32, 76, respectively, and deliver more positive torque without affecting print quality of respective printing units 10, 50.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing unit comprising:
an ink feed system;
a plate cylinder; and
an inker having multiple rollers and a belt wrapped around the rollers, the belt accepting ink from the ink feed system and transferring the ink to the plate cylinder.

2. The printing unit as recited in claim 1 further comprising a tensioning roller contacting the belt and maintaining a tension in the belt.

3. The printing unit as recited in claim 2 wherein the tensioning roller is displaced when the plate cylinder is thrown off.

4. The printing unit as recited in claim 2 wherein the tensioning roller is driven to translate the belt.

5. The printing unit as recited in claim 1 further comprising a vibrator roller contacting the belt, the vibrator roller oscillating back and forth across a width of the belt.

6. The printing unit as recited in claim 1 wherein at least one of the rollers is an idler roller.

7. The printing unit as recited in claim 1 wherein at least one of the rollers is a rider roller guiding the belt, the rider roller facilitating uniform distribution of the ink on the belt.

8. The printing unit as recited in claim 1 further comprising a water feed system delivering aqueous solution to the plate cylinder.

9. The printing unit as recited in claim 1 further comprising a blanket cylinder receiving inked images from the plate cylinder and printing the images on a substrate.

10. The printing unit as recited in claim 9 further comprising a backup cylinder contacting the substrate as the blanket cylinder prints images on the substrate.

11. A four color printing press comprising:
four printing units printing images on a web, each printing unit being a printing unit as recited in claim 1, the ink in each printing unit being a different color.

12. A method of printing comprising the steps of:
applying ink from an ink feed system to a belt;
moving the belt along a path of the belt; and
transferring the ink from the belt to a plate cylinder.

13. The method as recited in claim 12 further comprising transferring the ink from the plate cylinder to a substrate.

14. The method as recited in claim 12 further comprising transferring the ink from the plate cylinder to a blanket cylinder and transferring the ink from the blanket cylinder to a substrate.

15. The method as recited in claim 14 further comprising throwing the blanket cylinder off of the substrate.

16. The method as recited in claim 15 further comprising performing auto-transfer by printing images on the substrate with a second blanket cylinder while the blanket cylinder is thrown off of the substrate.

17. The method as recited in claim 15 further comprising throwing the plate cylinder off of the blanket cylinder and changing a plate on the plate cylinder via autoplating.

18. The method as recited in claim 17 further comprising changing a blanket on the blanket cylinder using an automated mechanism.

19. An inker comprising:
multiple rollers; and
an ink transfer belt wrapped around the rollers.

20. The inker as recited in claim 19 further comprising a tensioning roller contacting the belt and maintaining a tension in the belt.
